(19) United States
(12) Patent Application Publication
(10) Pub. No.: US 2024/0283302 A1
(43) Pub. Date: Aug. 22, 2024

(54) WIRELESS CHARGING DEVICE, SMARTPHONE KEY SYSTEM FOR VEHICLE, SMARTPHONE, VEHICLE, METHOD, AND NON-TRANSITORY COMPUTER-READABLE STORAGE MEDIUM

(71) Applicant: Hitachi-LG Data Storage, Inc., Tokyo (JP)

(72) Inventor: Kozo MASUDA, Tokyo (JP)

(21) Appl. No.: 18/388,881

(22) Filed: Nov. 13, 2023

(30) Foreign Application Priority Data
Feb. 20, 2023 (JP) 2023-024033

(51) Int. Cl. H02J 50/80; H02J 50/10

(52) U.S. Cl. CPC H02J 50/80; H02J 50/10; H02J 2310/22; H02J 2310/48

(57) ABSTRACT

A smartphone system for vehicle includes a key authentication device and a wireless charging device having a memory unit in which copy authentication information, which is authentication information for a copy of master authentication information held by a smartphone, is stored. The smartphone key system for vehicle selects and uses as the authentication information any of the master authentication information transmitted by wireless communication from the smartphone to a key authentication device and the copy authentication information stored in the memory unit, depending on a state of charging operation for the smartphone.

### CROSS-REFERENCE TO RELATED APPLICATION

The present application claims priority from Japanese Application JP2023-024033, filed on Feb. 20, 2023, the content of which is hereby incorporated by reference into this application.

### BACKGROUND OF THE INVENTION

### Field of the Invention

The present invention relates to a wireless charging device, a smartphone key system for vehicle, a key authentication device, a smartphone, a vehicle, a method, and a non-transitory computer-readable storage medium.

### Description of the Related Art

Electronic key system for vehicle that use a smartphone as a car key are becoming popular. Patent Document 1 (Japanese Patent No. 5979377) discloses a non-contact charging system with a control unit that synchronously controls a non-contact charging unit and a wireless communication unit (hereinafter referred to as a “conventional technology”).

The conventional technology has a control unit, a wireless communication unit, and a non-contact charging unit. The control unit is connected to the wireless communication unit and the non-contact charging unit.

The wireless communication unit communicates wirelessly with the electronic key to control the operation of the vehicle's electrical components. The non-contact charging unit supplies power to portable devices in a non-contact manner.

In the conventional technology, when wireless charging is being performed, “radio waves generated by the magnetic field of wireless charging” may interfere with “radio waves used for wireless communication with the electronic key” and adversely affect wireless communication for authentication. Therefore, the control unit sends control signals to the respective devices to stop the power supply operation of the non-contact charging unit to the portable device at the timing that allows the wireless communication unit to communicate with the electronic key.

### SUMMARY OF THE INVENTION

However, in the conventional technology, charging is stopped to avoid adverse effects of wireless charging on wireless communication for authentication, which increases the time required for charging from the point of first charging by the non-contact charging unit to the point where the battery of the portable device is fully charged. The present invention has been made to solve the above problems. That is, one of the objects of the present invention is to provide a wireless charging device, a smartphone key system for vehicles, a smartphone, a vehicle, a method, and a non-transitory computer-readable storage medium that can avoid adverse effects on wireless communication for authentication and reduce the possibility of an increase in the time required for charging.

In order to solve the above problem, the wireless charging device is installed in a vehicle. The wireless charging device is connected to a key authentication device configured to be capable of communicating wirelessly with a smartphone including a power receiving coil and a rechargeable battery that can be charged by power supplied from the power receiving coil, the key authentication device authenticating using authentication information.

The wireless charging device comprises:
a power transmitting unit that includes a power transmission coil and is capable of:
   communicating wirelessly with the smartphone through coil-to-coil communication via the power transmission coil and the power receiving coil; and
   transmitting power wirelessly via the power transmission coil to the power receiving coil;
a storage unit that stores copy authentication information, the copy authentication information being authentication information of a copy of master authentication information held by the smartphone; and
a control unit configured to instruct the key authentication device to select any one of the master authentication information and the copy authentication information for using as the authentication information depending on a state of charging operation to the smartphone, the master authentication information being transmitted from the smartphone to the key authentication device by wireless communication, the copy authentication information being stored in the memory unit, the copy authentication information being obtained from the smartphone by the coil-to-coil communication and transmitted by communication between the key authentication device and the wireless charging device.

The smartphone key system for vehicle uses a smartphone as a vehicle key. The smartphone includes a power receiving coil and a rechargeable battery that can be charged by power supplied from the power receiving coil.
the smartphone key system comprises:
a key authentication device that is configured to communicate wirelessly with the smartphone and authenticate using authentication information; and
a wireless charging device communicatively connected to the key authentication device,
the wireless charging device including the power transmission coil, the wireless charging device is capable of:
   communicating wirelessly with the smartphone through coil-to-coil communication via the power transmission coil and the power receiving coil, and
   transmitting power wirelessly via the power transmission coil to the power receiving coil, the wireless charging device including a storage unit that stores copy authentication information, the copy authentication information being authentication information of a copy of master authentication information held by the smartphone.

The smartphone key system is configured to select any one of the master authentication information and the copy authentication information for using as the authentication information depending on a state of charging operation to the smartphone, the master authentication information being transmitted from the smartphone to the key authentication device by the wireless communication, the copy authentication information being stored in the memory unit, the copy authentication information being obtained from the smartphone by the coil-to-coil communication and transmitted by communication between the key authentication device and the wireless charging device.

The smartphone is a smartphone used for the above-mentioned smartphone key system for vehicles.

The vehicle of the present invention is a vehicle to which the above-mentioned smartphone key system for vehicles is applied.

The method uses a computer applied to a smartphone key system for vehicle using a smartphone as a vehicle key, the smartphone including a power receiving coil and a rechargeable battery that can be charged by power supplied from the power receiving coil.

The smartphone key system comprises:
a key authentication device that is configured to communicate wirelessly with the smartphone and authenticate using authentication information; and
a wireless charging device communicatively connected to the key authentication device, the wireless charging device including the power transmission coil
the wireless charging device is capable of:
   communicating wirelessly with the smartphone through coil-to-coil communication via the power transmission coil and the power receiving coil, and
   transmitting power wirelessly via the power transmission coil to the power receiving coil, the wireless charging device including a storage unit that stores copy authentication information, the copy authentication information being authentication information of a copy of master authentication information held by the smartphone.

The method is to be executed performed using computer. The method comprises selecting any one of the master authentication information and the copy authentication information for using as the authentication information depending on a state of the charging operation to the smartphone, the master authentication information being transmitted from the smartphone to the key authentication device by the wireless communication, the copy authentication information being stored in the memory unit, the copy authentication information being obtained from the smartphone by the coil-to-coil communication and transmitted by communication between the key authentication device and the wireless charging device.

The non-transitory computer-readable storage medium stores a computer-executable program executed by a computer, the program comprising instructions for executing the above method.

According to the present invention, adverse effects on wireless communication for authentication can be avoided and the possibility of an increase in the time required for recharging can be reduced. The effects described herein are not necessarily limited to those described in this disclosure, but may be any of the effects described in this disclosure.

### BRIEF DESCRIPTION OF DRAWINGS

FIG. 1 is a configuration diagram showing an example system configuration of a smartphone key system for vehicles (smartphone key system).

FIG. 2 illustrates the principle of FSK modulation and ASK modulation.

FIG. 3A shows the sequence diagram when a user uses the smartphone key system.

FIG. 3B shows the sequence diagram when a user uses the smartphone key system.

FIG. 3C shows the sequence diagram when a user uses the smartphone key system.

FIG. 4 is a flowchart illustrating the process performed by the key ID server.

FIG. 5 is a flowchart to illustrate the process performed by the WCU.

FIG. 6 is a flowchart to illustrate the process performed by the phone.

FIG. 7 is a flowchart to illustrate the process performed by the vehicle body control ECU.

FIG. 8 is a flowchart to illustrate the process performed by the key control ECU.

FIG. 9 is a configuration diagram showing an example system configuration of a smartphone key system.

FIG. 10A shows the sequence diagram when a user uses the smartphone key system.

FIG. 10B shows the sequence diagram when a user uses the smartphone key system.

FIG. 10C shows the sequence diagram when a user uses the smartphone key system.

FIG. 11A is a flowchart to illustrate the process performed by the phone.

FIG. 11B is a flowchart to illustrate the process performed by the phone.

FIG. 12 is a flowchart to illustrate the process performed by the vehicle body control ECU.

FIG. 13 is a flowchart illustrating the process performed by the key control ECU.

### DETAILED DESCRIPTION OF THE EMBODIMENT

Each embodiment of the present invention will be described below with reference to the drawings. In all figures of the embodiments, identical or corresponding parts may be marked with the same symbol. In the following description, the functional block may be used as the subject to explain the process, but the subject of the process may be a CPU or a device instead of a functional block. When describing identification information, the expression “ID” is used, but other expressions may be used.

### First Embodiment

This unit describes a smartphone key system for vehicle that includes a wireless charging device (hereinafter referred to as the “first smartphone key system”).

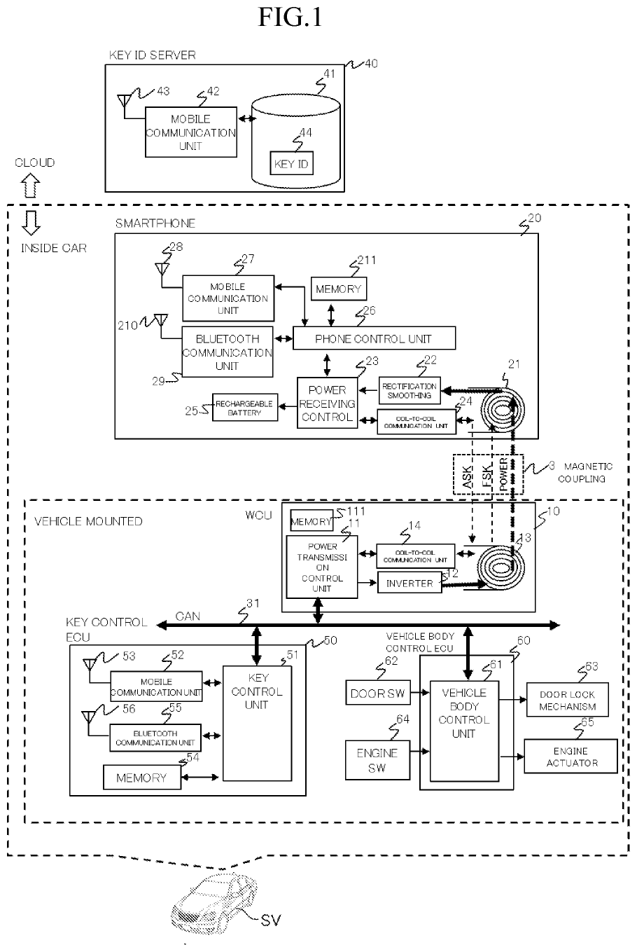

FIG. 1 is a configuration diagram showing an example system configuration of the first smartphone key system. The first smartphone key system is applied to a vehicle SV. The first smartphone key system consists of a WCU (wireless charging unit) 10, a smartphone 20, a key ID server 40, a key control ECU 50, and a vehicle body control ECU 60. The WCU 10 is also referred to as a “wireless charging device” and corresponds to the wireless charging device according to the first embodiment. The vehicle SV includes the WCU 10, the key control ECU 50, and the vehicle body control ECU 60.

The smartphone 20 and the key ID server 40 are configured to send and receive information by wireless mobile communication. The key ID server 40 and the key control ECU 50 are configured to be capable of sending and receiving information by wireless mobile communication. The smartphone 20 and the key control ECU 50 are configured to be capable of sending and receiving information by wireless mobile communication (Bluetooth communication). Bluetooth” is a registered trademark. The WCU 10, the key control ECU 50, and the vehicle body control ECU 60 are configured to be capable of sending and receiving information to and from each other via CAN (Controller Area Network) 31.

The WCU 10 has a power transmission control unit 11, an inverter 12, a coil 13, a coil-to-coil communication unit 14, and a memory 111. It should be noted that the power transmission control unit 11 may also be referred to as the “control unit” for convenience, and the coil 13 may be referred to as the “transmission coil” for convenience.

The power transmission control unit 11 includes a power transmission control circuit including a microcomputer and controls the AC power supplied to the coil 13. The power transmission control unit 11 also has functions such as communicating with each of the key control ECU 50 and the vehicle body control ECU 60 via CAN 31. These functions are realized, for example, by the CPU executing a program stored in ROM. The power transmission control unit 11 is connected to the coil-to-coil communication unit 14 to enable input/output of information.

When the accessory power supply (ACC power supply) of the vehicle SV is supplied, the DC power supplied from the battery power supply of the vehicle SV is input to the inverter 12. The inverter 12 converts the input DC power into AC power required for excitation of the coil 13, and supplies the converted AC power to the coil 13. The power transmission control unit 11 controls the AC power supplied to the coil 13 by controlling the state of the switch, not shown, provided by the inverter 12 to ON or OFF.

The coil-to-coil communication unit 14 uses the coil 13 and the coil 21 to perform bidirectional coil-to-coil communication with the coil-to-coil communication unit 24 of the smartphone 20.

The coil-to-coil communication unit 14 transmits information by using AC power supplied from the inverter 12 to the coil 13 as a carrier wave, superimposing an information signal indicating the information to be transmitted. Specifically, the coil-to-coil communication unit 14 modulates and transmits information using the AC power transmitted to the coil 21 via the coil 13. The coil-to-coil communication unit 14 receives information signals transmitted from the coil-to-coil communication unit 24 using AC power, and demodulates the received information signals to obtain information.

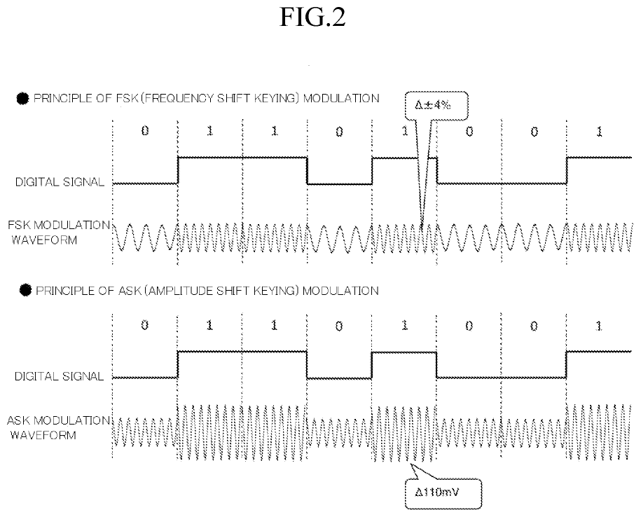

For example, ASK (Amplitude Shift Keying), FSK (Frequency Shift Keying), or the like is used for modulation and demodulation methods used in coil-to-coil communication. As shown in FIG. 2, ASK is a digital modulation method that changes the carrier wave discontinuously and expresses the data to be transmitted by changing the amplitude of the carrier wave. The amplitude is changed by 4110 mV, for example. FSK is one of the digital modulation schemes that change the carrier wave discontinuously, and expresses the data to be transmitted by changing the frequency of the carrier wave. For example, the frequency is changed by Δ±4%. FSK is used, for example, for the transmission of information from the transmitter side to the receiver side.

The coil 13 is composed of coiled conductive material and is used for magnetic coupling 3 with coil 21 of the smartphone 20, for coil-to-coil communication with the smartphone 20, and for transmitting (feeding) power to the smartphone 20.

The memory 111 is a storage medium (storage device) capable of storing information (data) and consists of a nonvolatile memory capable of reading and writing data.

The smartphone 20 includes a microcomputer or similar device that includes a CPU, ROM, RAM, interface I/F and non-volatile memory that can read and write data.

The smartphone 20 is equipped with a coil 21, a rectifying and smoothing unit 22, a power receiving control unit 23, a coil-to-coil communication unit 24, a rechargeable battery (secondary battery) 25, a phone control unit 26, a mobile communication unit 27, an antenna 28, a Bluetooth communication unit 29, and an antenna 210. It should be noted that the coil 21 may be referred to as the “power receiving coil” for convenience.

The coil 21 is composed of coiled conductive material and is used for the magnetic coupling 3 with the coil 13 of the WCU 10, for the coil-to-coil communication with the WCU 10, and for receiving power from the WCU 10.

The coil-to-coil communication unit 24 performs coil-to-coil communication with the coil-to-coil communication unit 14 of the WCU 10 via the coil 21 and the coil 13. The coil-to-coil communication unit 24 modulates and transmits information using AC power transmitted to the coil 21 via the coil 13. For example, ASK is used for this transmission of information from the receiving side to the transmitting side. The coil-to-coil communication unit 24 receives information signals transmitted from the coil-to-coil communication unit 14 using AC power and demodulates the received information signals to obtain information.

The rectifying and smoothing unit 22 is composed of a circuit using, for example, a semiconductor diode and a capacitor. The rectifying and smoothing unit 22 converts the alternating current of the coil 21 received from the coil 21 by mutual dielectric action into direct current by rectifying and smoothing, and supplies the converted direct current to the power receiving control unit 23. The power receiving control unit 23 controls the charging current and charging voltage, etc. supplied to the rechargeable battery 25 to charge the rechargeable battery 25.

The telephone control unit 26 consists of a microcomputer and executes control to realize various functions that the smartphone 20 has, including the smartphone key function and the telephone function. For example, ROM and/or non-volatile memory stores applications, etc. including key applications for realizing the smartphone key function, and the CPU executes the key applications stored in ROM and/or non-volatile memory to realize various functions for using the smartphone 20 as a key.

The memory 211 is a storage medium (storage device) capable of storing information (data) and consists of nonvolatile memory capable of reading and writing data.

The mobile communication unit 27 comprises a mobile communication module connected to the antenna 28 and is connected to the mobile communication unit 42 of key ID server 40 so as to be capable of wireless communication. The Bluetooth communication unit 29 comprises a Bluetooth communication module connected to the antenna 210 and is connected to the Bluetooth communication unit 55 of the key control ECU 50 so as to be capable of wireless communication.

The key ID server 40 consists of a computer (server, information processor) or the like, including a CPU, a ROM, a RAM, an interface I/F, and a nonvolatile storage device capable of reading and writing data, etc. The CPU executes a program stored in the ROM to realize various functions. The key ID server 40 may comprise multiple servers and is not limited to a physical server, but may be a virtual server in the cloud.

The key ID server 40 comprises a storage unit 41, a mobile communication unit 42, and an antenna 43. The memory unit 41 comprises a nonvolatile storage device capable of reading and writing data. The memory unit 41 maintains (stores and stores) a database 44 in which key IDs used for key authentication are stored. The key ID may be referred to as “authentication information”.

The mobile communication unit 42 consists of a mobile communication module connected to an antenna 43, which is connected to the mobile communication unit 27 of the smartphone 20 and the mobile communication unit 52 of the key control ECU 50, respectively, for wireless communication.

The key control ECU 50 is an electric control unit (ECU) with a microcomputer as its main part. The microcomputer includes a CPU, a ROM, a RAM, a data readable and writable nonvolatile memory, interfaces, etc. The CPU executes a program stored in the ROM to realize various functions. The key control ECU 50 may also be referred to as a “key authentication device” for convenience.

The key control ECU 50 comprises a key control unit 51, a mobile communication unit 52, an antenna 53, a memory 54, a Bluetooth communication unit 55, and an antenna 56. The key control unit 51 is composed of a microcomputer. The mobile communication unit 52 comprises a mobile communication module connected to the antenna 53, which is connected to the mobile communication unit 42 of the key ID server 40 for mobile communication. The Bluetooth communication unit 55 comprises a Bluetooth communication module connected to the antenna 56, which is connected to the Bluetooth communication unit 29 of the smartphone 20 for wireless communication.

The vehicle control ECU 60 is an electric control unit (ECU) with a microcomputer as its main part. The microcomputer includes a CPU, a ROM, a RAM, a data readable and writable nonvolatile memory, and an interface, etc. The CPU executes a program stored in the ROM to realize various functions.

The vehicle body control ECU 60 is equipped with a vehicle body control unit 61. The vehicle body control unit 61 is composed of a microcomputer. The vehicle body control ECU 60 is connected to the door SW 62 and the engine SW 64. The door SW 62 is provided, for example, on the outside handle, which is not shown in the figure, provided by the vehicle SV. The door SW 62 is operated by being pressed by the user. When the door SW 62 is operated by the user, the door SW 62 transmits an operation signal to the vehicle body control ECU 60 indicating that the door SW has been operated.

The engine SW 64 is located, for example, in front of the driver's seat. The engine SW 64 is a switch operated by the user (driver) to start or stop the engine, which is not shown in the figure. The engine SW 64 is operated by being pressed by the user (driver). When the engine SW 64 is operated by the user, the engine SW 64 transmits an operation signal to the vehicle body control ECU 60 indicating that the engine SW 64 has been operated.

For example, when the engine SW 64 is pressed once without stepping on the brake, the vehicle body control ECU 60 turns on the accessory power supply that supplies power to the on-board accessories including the WCU10. When the engine SW 64 is pressed once with the brake depressed, the vehicle body control ECU 60 turns on both the accessory power supply and the ignition power supply (IG power supply) used to control engine operation. The vehicle body control ECU 60 turns on the ignition power supply to activate the starter to start the engine. When the engine SW 64 is pressed once with the shift lever position in the “P” position, the vehicle body control ECU 60 turns off the accessory power and ignition power to stop the engine.

The vehicle control ECU 60 is connected to the door lock mechanism 63. The vehicle control ECU 60 operate the door lock mechanism 63 to set a state of the vehicle SV to a lock state or a unlock state. The lock state is also referred to as a “door lock state and the unlock state is also referred to as a “door unlock state”.

The vehicle control ECU 60 is connected to the engine actuator 65. The engine actuator 65 includes a throttle valve actuator that changes the opening degree of the throttle valve of the engine (internal combustion engine) provided with the vehicle SV. The vehicle control ECU 60 controls the driving force of the vehicle SV by controlling the engine actuator 65 in response to the operation of the accelerator pedal, etc., which is not shown in the figure.

### <Overview>

The following is an overview of the present invention. The first smartphone key system is a smart entry system that uses the smartphone 20 as a key for a vehicle SV to lock and unlock the doors provided by the vehicle SV, and to start and stop the engine. In the first smartphone key system, the smartphone 20 that enters within a certain distance of the vehicle SV communicates with a device installed in the vehicle SV to perform the key authentication. The key ID required for authentication is transmitted from the key ID server 40 to each of the smartphone 20 and the key control ECU 50, and stored in each of the memory 211 of the smartphone 20 and the memory 54 of the key control ECU 50.

When the key authentication is requested, the key control ECU 50 receives the key ID directly from the smartphone 20 or the key ID that has been obtained from the smartphone 20 and stored in the WCU 10, and determines whether the received key ID matches the key ID held by the key control ECU 50 (i.e., performs key matching), to thereby perform the key authentication. When the received key ID and the key ID held by the key control ECU 50 match, the key control ECU 50 determines that the key authentication has succeeded. When the received key ID does not match the key ID held by the key control ECU 50, the key control ECU 50 determines that the key authentication has failed.

By the way, in the conventional smartphone key system, when the WCU10 is in a state in which wireless charging is being performed to the smartphone 20 (charging execution state), “radio waves generated by the magnetic field of wireless charging” may interfere with “radio waves used by the smartphone 20 and the key control ECU 50 for communication for the key authentication (wireless communication)”. This may interfere with the wireless communication for authentication.

In contrast, this problem could be avoided if charging is stopped during the key authentication communication. However, in this case, the time efficiency of charging would be reduced, and the time required for charging from the start of charging to a full charge would increase. Furthermore, since the number of recharging cycles increases, the rechargeable battery 25 of the smartphone 20 may easily deteriorate.

Therefore, in the first smartphone key system, when the WCU 10 is not charging the smartphone 20 (non-charging state), the key authentication is performed through wireless communication between the smartphone 20 and the key control ECU 50. The key ID stored in the memory 211 of the smartphone 20 used for the key authentication at this time may be referred to as “master authentication information” for convenience.

When the WCU10 is charging to the smartphone 20 (charging execution state), the key ID acquired through the coil-to-coil communication between the smartphone 20 and the WCU10 is stored in the memory 111 of the WCU10, and the stored key ID is transmitted through CAN communication between the WCU10 and the key control ECU 50 to perform the key authentication. This key ID stored in memory 111 may be referred to as “copy key ID” or “copy authentication information” for convenience.

According to the first smartphone key system, when the WCU 10 is charging to the smartphone 20 (charging execution state), without stopping charging, the smartphone 20 communicates (wired communication) with the WCU 10 and the key control ECU 50 for the key authentication using the key ID stored in the WCU 10 to thereby be able to perform the key authentication. Thus, the first smartphone key system can avoid adverse effects on wireless communication for authentication and reduce the possibility of an increase in the time required for recharging. Furthermore, the first smartphone key system can charge at maximum efficiency because it does not need to answer the key ID during charging. Furthermore, the first smartphone key system can reduce the number of recharges, thus reducing the possibility of the rechargeable battery 25 deteriorating easily. Furthermore, the first smartphone key system copies the key ID to the WCU10 for key detection with priority while the rechargeable battery 25 is charging, thus stabilizing communication.

### <Overall Operation of First Smartphone Key System>

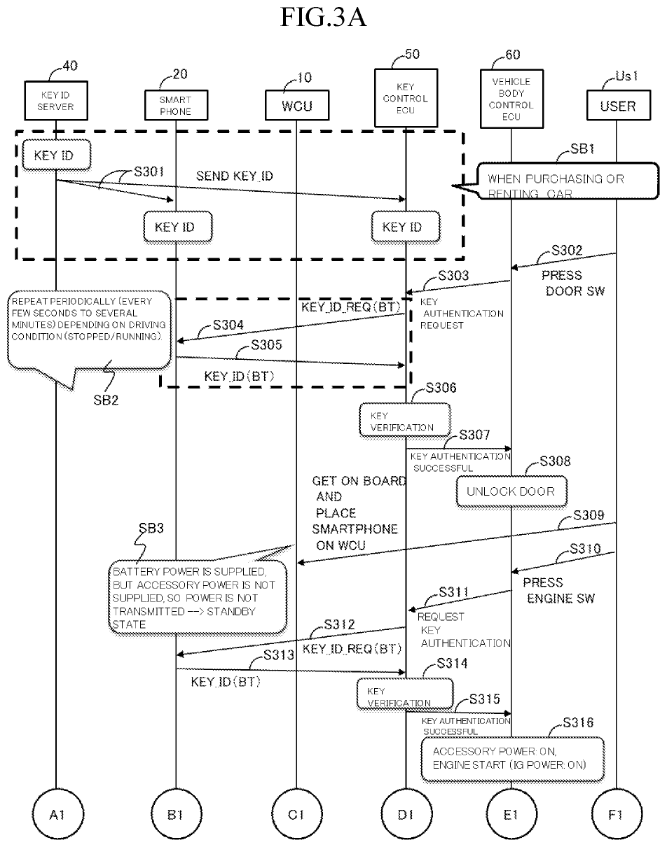

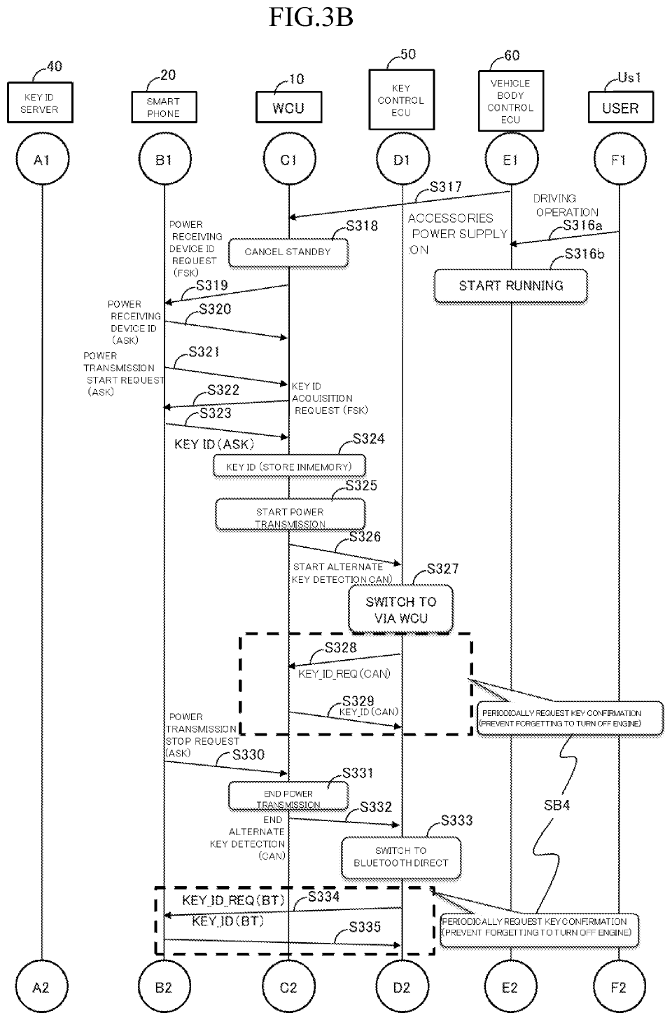

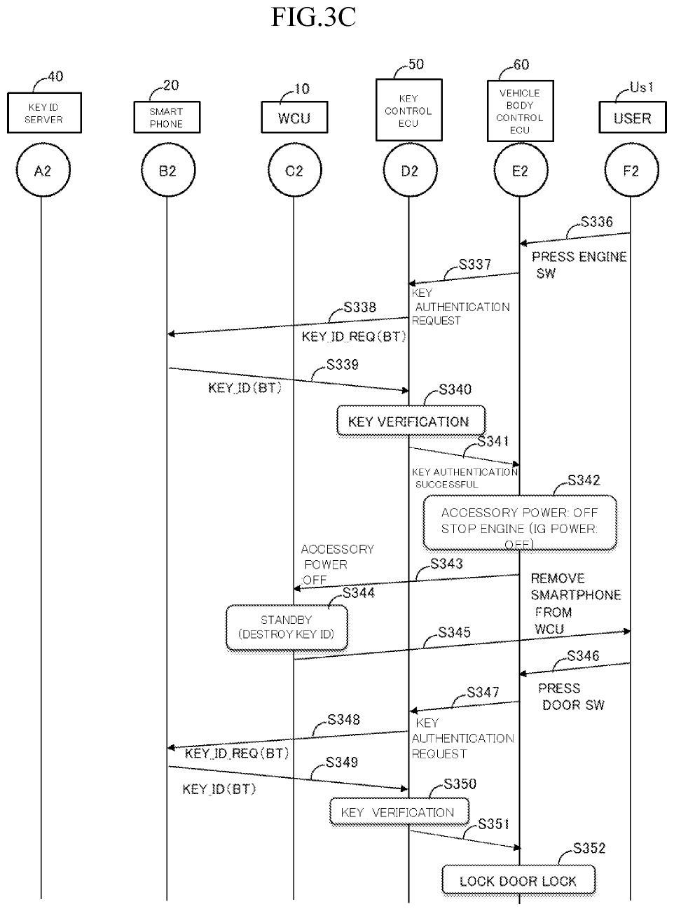

FIG. 3A through FIG. 3C are sequence diagrams to explain the respective operations of the key ID server 40, the smartphone 20, the WCU 10, the key control ECU 50 and the car body control ECU 60 when a user Us1 uses the first smartphone key system.
S301: The key ID server 40 sends the key ID (denoted as “KEY ID” in FIGS. 3A to 3C) to the smartphone 20 and the key control ECU 50. The smartphone 20 receives the key ID and saves (memorizes and stores) it in the memory 211. The key control ECU 50 receives the key ID and saves (memorizes and stores) it in the memory 54. As shown in the description of a speech bubble SB1, the operation of S301 is performed, for example, at the time of car purchase or, in the case of a rental car, at the time of rental.
S302: The user Us1 presses door SW 62 while carrying the smartphone 20.
S303: The vehicle body control ECU 60 receives the operation signal from the door SW 62 and sends a key authentication request to the key control ECU 50.
S304: When the key control ECU 50 receives the key authentication request, it sends the key ID request to the smartphone 20 via Bluetooth communication.
S305: When the smartphone 20 receives the key ID request from the key control ECU 50, it transmits the key ID to the key control ECU 50 via Bluetooth communication. As shown in the explanation of a speech bubble SB2, the key control ECU 50 periodically and repeatedly sends the key ID request in S304 at a cycle (e.g., a cycle of several seconds or minutes) according to the driving status (stop or run) of the vehicle SV. If the key ID in response to the key ID request is not received from the smartphone 20, it can be determined that the user Us1 is likely to be away from the vehicle SV that forgot to turn off the engine, because the smartphone 20 is likely to be outside the predetermined range of the vehicle SV even though the engine is on. Since the situation of forgetting to turn off the engine is more likely to occur when the vehicle SV is at a standstill, the key ID request should be transmitted more frequently in the standstill state than in the driving state. Thus, for example, the cycle should be set so that the cycle when the vehicle SV is stopped is shorter than the cycle when the vehicle SV is running.
S306: When the key control ECU 50 receives the key ID from the smartphone 20, it performs the key authentication by matching the key with the received key ID. That is, the key control ECU 50 performs the key authentication by determining whether the received key ID matches the key ID stored in the memory 54. If the received key ID and the key ID stored in the memory 54 match, the key authentication succeeds. If the received key ID and the key ID stored in the memory 54 do not match, the key authentication fails.
S307: The key control ECU 50 successfully authenticates the key and transmits the key authentication result to the vehicle body control ECU 60.
S308: When the vehicle body control ECU 60 receives the key authentication result, it unlocks the door (a door lock state) by the door lock mechanism 63 (the door is not locked by the door lock mechanism 63 (a door unlock state)).
S309: The user Us1 gets into the vehicle SV and places the phone 20 on the WCU10. As shown in the explanation of a speech bubble SB3, the WCU10 is supplied with battery power (constant power) but no accessory power, so the WCU10 is in standby mode with no power transmission.
S310: The user Us1 presses the engine SW 64.
S311: The vehicle body control ECU 60 receives the operation signal from the engine SW 64 and sends a key authentication request to the key control ECU 50.
S312: When the key control ECU 50 receives the key authentication request, it sends the key ID request to the smartphone 20 via Bluetooth communication.
S313: When the smartphone 20 receives the key ID request from the key control ECU 50, it sends the key ID to the key control ECU 50 via Bluetooth communication.
S314: When the key control ECU 50 receives the key ID from the smartphone 20, it performs the key authentication by matching the key with the received key ID.
S315: The key control ECU 50 successfully authenticates the key and transmits the key authentication result to the vehicle body control ECU 60.
S316: When the vehicle body control ECU 60 receives the key authentication result, it turns on the accessory power and ignition power and starts the engine.
S316a: The User Us1 performs driving operations (steering wheel operation, gas pedal operation, and brake operation) to drive the vehicle SV.
S316b: The vehicle body control ECU 60 starts driving the vehicle SV according to the driving operation of the user Us1.
S317: The WCU10 detects that the vehicle body control ECU60 has turned on the accessory power.
S318: The WCU10 releases the standby state (the standby state waiting to detect and transmit power from the smartphone 20).
S319: The WCU10 sends a power receiving device ID request to the smartphone 20 through coil-to-coil communication using FSK.
S320: When the smartphone 20 receives the power receiving device ID request, it sends the power receiving device ID to the WCU 10 through coil-to-coil communication using ASK.
S321: The smartphone 20 sends a power transmission start request to the WCU 10 through coil-to-coil communication using ASK.
S322: When the WCU10 receives the power transmission start request from the smartphone 20, it sends a key ID acquisition request to the smartphone 20 through coil-to-coil communication using FSK.
S323: When the smartphone 20 receives the key ID acquisition request, it sends the key ID to the WCU 10 through coil-to-coil communication using ASK.
S324: When the WCU10 receives the key ID, it saves (memorizes or stores) the key ID in memory 211.
S325: The WCU10 starts power transmission to the smartphone 20.
S326: The WCU10 sends a command to the key control ECU 50 to start alternative key detection via CAN communication.
S327: When the key control ECU 50 receives a command from the WCU 10 to start alternative key detection, it switches to key ID detection via WCU 10. At this time, Bluetooth communication should not be disconnected to prevent connection delays in case Bluetooth communication needs to be used again later.
S328: The key control ECU 50 sends a key ID request to the WCU 10 via CAN communication. As shown in the explanation of a speech bubble SB4, this key ID request is a periodic key confirmation request to determine if the engine has been turned off, as described above.
S329: The WCU10 sends a key ID acquisition request to the smartphone 20 through coil-to-coil communication using FSK.
S330: The smartphone 20 sends a power transmission stop request to the WCU 10 through coil-to-coil communication using ASK.
S331: When the WCU10 receives the power transmission stop request, it stops power transmission to the smartphone 20 (terminates power transmission).
S332: The WCU10 sends a command to the key control ECU 50 to terminate alternative key detection via CAN communication.
S333: When the key control ECU 50 receives a command from the WCU10 to terminate alternative key detection, it switches to Bluetooth direct (the communication used for key detection is switched to Bluetooth communication). It should be noted that at this time, if the Bluetooth communication has not been disconnected as described above, the communication used for key detection can be smoothly switched to Bluetooth communication.
S334: The key control ECU 50 sends a key ID request to the smartphone 20 via Bluetooth communication. It should be noted that as shown in the explanation of a speech bubble SB4, this key ID request is a periodic key confirmation request to determine if the engine is turned off, as described above.
S335: When the smartphone 20 receives a key ID request from the key control ECU 50, it sends the key ID to the key control ECU 50 via Bluetooth communication.
S336: The User Us1 presses the engine SW 64.
S337: When the vehicle body control ECU 60 receives an operation signal from the engine SW 64, it sends a key authentication request to the key control ECU 50 via CAN communication.
S338: When the key control ECU 50 receives the key authentication request from the vehicle body control ECU 60, it sends a key ID request to the smartphone 20 via Bluetooth communication.
S339: The smartphone 20 transmits the key ID to the key control ECU 50 via Bluetooth communication.
S340: When the key control ECU 50 receives the key ID from the smartphone 20, it performs the key authentication by matching the key with the received key ID.
S341: The key control ECU 50 successfully authenticates the key and transmits the key authentication result to the vehicle body control ECU 60 via CAN communication.
S342: When the vehicle body control ECU 60 receives the key authentication result, it turns off the accessory and ignition power supplies and stops the engine.
S343: The WCU 10 detects that the vehicle body control ECU 60 has turned off the accessory power.
S344: The WCU10 enters standby mode when the accessory power is turned off. At this time, the key ID is discarded.
S345: The User Us1 removes the phone 20 from the WCU10.
S346: The User Us1 presses the door SW 62.
S347: The vehicle body control ECU 60 receives the operation signal from the door SW 62 and sends a key authentication request to the key control ECU 50 via CAN communication.
S348: When the key control ECU 50 receives a key authentication request from the vehicle body control ECU 60, it sends a key ID request to the smartphone 20 via Bluetooth communication.
S349: When the smartphone 20 receives the key ID request from the key control ECU 50, it sends the key ID to the key control ECU 50 via Bluetooth communication.
S350: When the key control ECU 50 receives the key ID from the smartphone 20, it performs the key authentication by matching the key with the received key ID.
S351: The key control ECU 50 successfully authenticates the key and transmits the key authentication result to the vehicle body control ECU 60 via CAN communication.
S352: When the vehicle body control ECU 60 receives the key authentication result, it locks the doors (changes from the door unlocked state to the door locked state).

### <Specific Operation>

The specific operation of the key ID server 40, the smartphone 20, the WCU 10, the key control ECU 50, and the vehicle body control ECU 60 is described below.

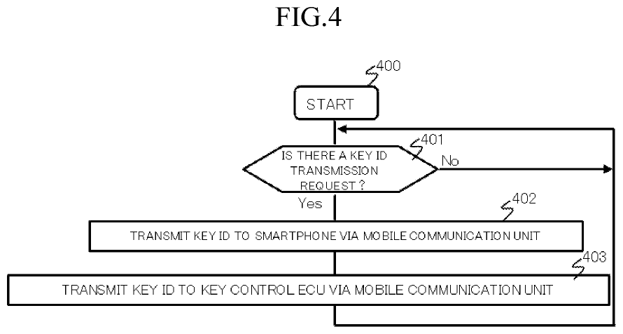

FIG. 4 shows a flowchart describing the process performed by the key registration (see S301 in FIG. 3A), which is executed, for example, at the time of car purchase or rental, as described above. The key control unit 51 of the key ID server 40 starts the process from step 400 and proceeds to step 401 to determine whether there is a key ID transmission request from the smartphone 20 and the key control ECU 50.

When there is no key ID transmission request, the key control unit 51 makes a “No” determination at step 401 and executes the process of step 401 again. When there is a key ID transmission request, the key control unit 51 makes a “Yes” determination at step 401, executes steps 402 and 403 described below in sequence, and then returns to step 401.

Step 402: The key control unit 51 transmits the key ID to the smartphone 20 via the mobile communication unit 27.

Step 403: The key control unit 51 transmits the key ID to the key control ECU 50 via the mobile communication unit 27.

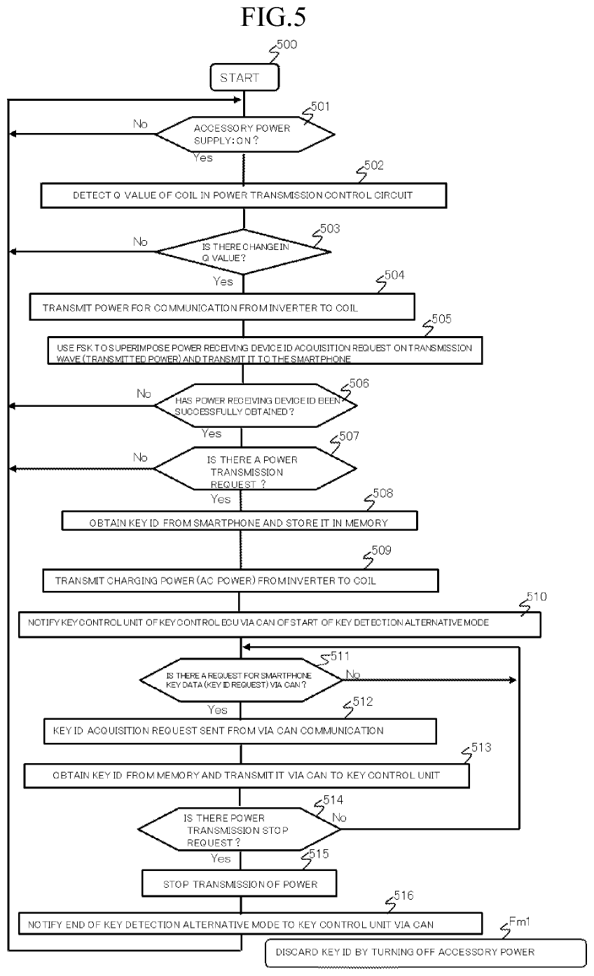

FIG. 5 is a flowchart illustrating the process performed by the power transmission control unit 11 of the WCU 10 to charge the smartphone 20 and to perform the key authentication when charging the smartphone 20, as described above.

The power transmission control unit 11 of the WCU 10 starts the process at step 500 and proceeds to step 501 to determine whether the accessory power supply is in the ON state.

When the accessory power supply is not in the ON state, the transmission control unit 11 makes a “No” determination at step 501 and executes the process of step 501 again.

When the accessory power supply is in the ON state, the power transmission control unit 11 makes a “Yes” determination at step 501 and proceeds to step 502 to detect a Q value of the coil in the power transmission control circuit.

The transmission control unit 11 then proceeds to step 503 to determine whether there is a change in the Q value. This determination is made by comparing a parameter indicating a change in the Q value (e.g., the amount of change in the Q value from a predetermined reference value) with a predetermined threshold value.

When there is no change in the Q value, the transmission control unit 11 makes a “No” determination at step 503 and returns to step 501.

When there is a change in the Q value, the transmission control unit 11 makes a “Yes” determination at step 503, executes steps 504 and 505 described below in sequence, and then proceeds to step 506.

Step 504: The transmission control unit 11 transmits power for communication from the inverter 12 to the coil 13.

Step 505: The power transmission control unit 11 uses FSK to superimpose the power receiving device ID acquisition request on the transmission wave (transmitted power) and transmits it to the smartphone 20.

The power transmission control unit 11 proceeds to step 506 to determine whether the power receiving device ID has been successfully obtained.

When the power receiving device ID has not been successfully obtained, the transmission controller 11 makes a “No” determination at step 506 and returns to step 501.

When the power receiving device ID is successfully obtained, the power transmission control unit 11 makes a “Yes” determination at step 506 and proceeds to step 507 to determine whether there is a power transmission request from the smartphone 20.

When there is no power transmission request, the transmission controller 11 makes a “No” determination at step 507 and returns to step 501.

When there is a power transmission request, the transmission control unit 11 makes a “Yes” determination at step 507, executes steps 508 through 510 described below in sequence, and then proceeds to step 511.

Step 508: The power transmission control unit 11 obtains the key ID from the smartphone 20 and stores it in the memory 111.

Step 509: The power transmission control unit 11 transmits charging power (AC power) from the inverter 12 to the coil 13.

Step 510: The power transmission control unit 11 notifies the key control unit 51 of the key control ECU 50 via CAN of the start of the key detection alternative mode.

The power transmission control unit 11 proceeds to step 511 to determine whether there is a request for smartphone key data (key ID request) from the key control ECU 50 via CAN communication.

When there is no request for smartphone key data (key ID request), the transmission control unit 11 makes a “No” determination at step 511 and executes the process of step 511 again.

When there is a request for smartphone key data (key ID request), the transmission control unit 11 makes a “Yes” determination at step 511, executes steps 512 and 513 described below in sequence, and then proceeds to step 514.

Step 512: The transmission control unit 11 receives a key ID acquisition request sent from the key control ECU 50 via CAN communication.

Step 513: The power transmission control unit 11 obtains the key ID from memory 111 and transmits it via CAN to the key control unit 51 of the key control ECU 50.

The transmission control unit 11 proceeds to step 514 to determine whether there is a power transmission stop request from the smartphone 20.

When there is no power transmission stop request, the transmission control unit 11 makes a “No” determination at step 514 and returns to step 510.

When there is a power transmission stop request, the transmission control unit 11 makes a “Yes” determination at step 514, executes steps 515 and 516 described below in sequence, and then returns to step 501.

Step 515: The transmission control unit 11 stops transmission of power to the smartphone 20.

Step 516: The power transmission control unit 11 notifies the key control unit 51 of the key control ECU 50 via CAN of the end of the key detection alternative mode. When the accessory power supply is subsequently turned off, the power transmission control unit 11 discards the key ID stored (memorized and stored) in the memory 111 from the viewpoint of improving security (see explanation of frame Fm1).

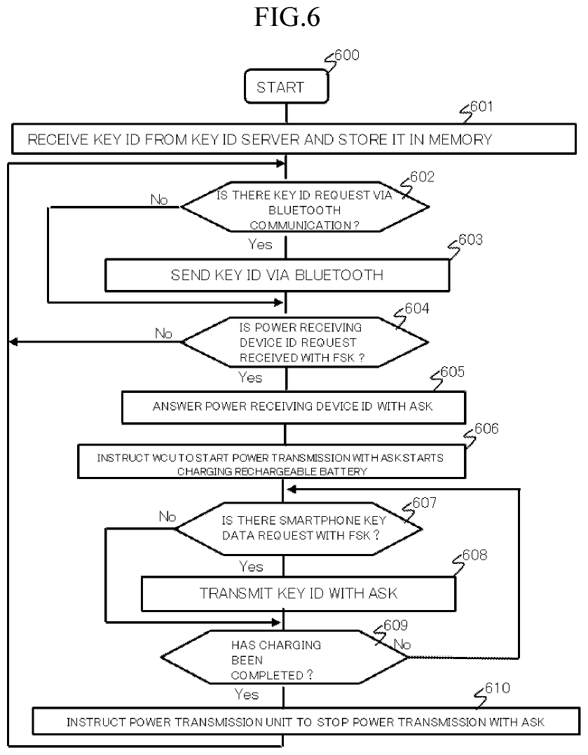

FIG. 6 is a flowchart to illustrate the process performed by the smartphone 20 to perform the key authentication when the smartphone 20 is charged and uncharged as described above. The power receiving control unit 23 of the smartphone 20 starts the process at step 600 and proceeds to step 601 to receive the key ID from the key ID server 40 and store it in memory 211.

The power receiving control unit 23 then proceeds to step 602 to determine whether there is a key ID request from the key control ECU 50 via Bluetooth communication.

When there is a key ID request, the power receiving control unit 23 makes a “Yes” determination at step 602 and proceeds to step 603 to send the key ID to the key control ECU 50 via Bluetooth communication and proceeds to step 604.

When there is no key ID request, the power receiving control unit 23 makes a “No” determination at step 602 and proceeds directly to step 604.

The power receiving control unit 23 proceeds to step 604 to determine whether a power receiving device ID request is received from the WCU 10 with FSK.

When the power receiving device ID request has not been received, the power receiving control unit 23 makes a “No” determination at step 604 and returns to step 602.

When a power receiving device ID request is received, the power receiving control unit 23 makes a “Yes” determination at step 604, performs steps 605 and 606 described below in sequence, and then proceeds to step 607.

Step 605: The power receiving control unit 23 answers the WCU 10 with the power receiving device ID with ASK.

Step 606: The power receiving control unit 23 instructs the WCU 10 to start power transmission with ASK. The power receiving control unit 23 starts charging the rechargeable battery 25 with the power transmitted from the WCU10.

The power receiving control unit 23 proceeds to step 607 to determine whether there is a smartphone key data request (key ID request) with FSK from the WCU10.

When there is a request for smartphone key data (key ID request), the power receiving control unit 23 makes a “Yes” determination at step 607 and proceeds to step 608, transmits the key ID to the WCU10 with ASK, and proceeds to step 609.

When there is no request for smartphone key data (key ID request), the power receiving control unit 23 makes a “No” determination at step 607 and proceeds directly to step 609.

The power receiving control unit 23 proceeds to step 609 to determine whether charging has been completed. When charging is not completed, the power receiving control unit 23 makes a “No” determination at step 609 and returns to step 607. When charging is completed/finished, the power receiving control unit 23 makes a “Yes” determination at step 609 and proceeds to step 610 to instruct the power transmission unit of the WCU 10 to stop power transmission with ASK and returns to step 602.

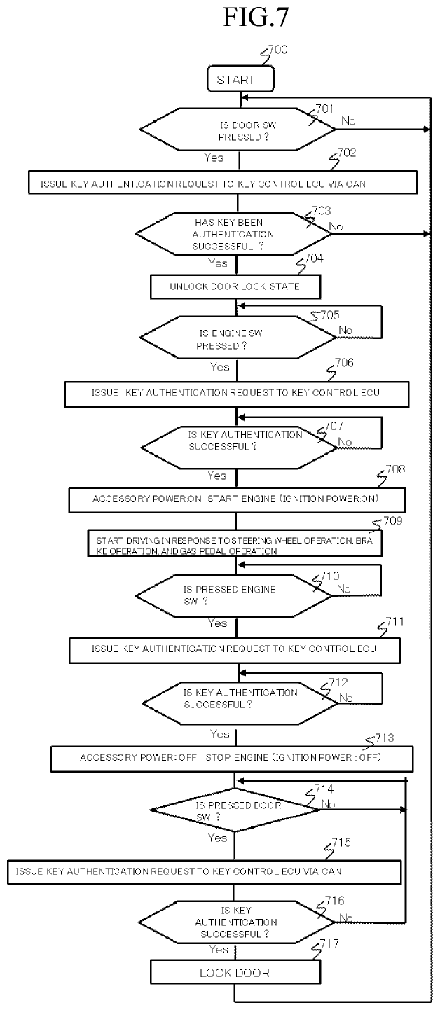

FIG. 7 is a flowchart to explain the process performed by the vehicle body control ECU 60 to perform the key authentication as described above and to control the operation of the vehicle SV according to the operation of each SW by the user Us1 and the result of the key authentication.

The vehicle body control unit 61 of the vehicle control ECU 60 starts the process from step 700 and proceeds to step 701 to determine whether the door SW 62 is pressed based on the operation signal from the door SW 62.

When the door SW 62 is not pressed, the car body control unit 61 makes a “No” determination at step 701 and executes the process of step 701 again.

When the door SW 62 is pressed, the vehicle body control unit 61 makes a “Yes” determination at step 701 and proceeds to step 702 to issue a key authentication request to the key control ECU 50 via CAN communication.

The vehicle body control unit 61 then proceeds to step 703 to determine whether the key authentication by the key control ECU 50 has been successful or not. When the key authentication was not successful, the vehicle body control unit 61 makes “No” determination at step 703 and returns to step 701. When the key authentication was successful, the vehicle body control unit 61 makes a “Yes” determination at step 703 and proceeds to step 704 to unlock the door lock state by the door lock mechanism 63.

The vehicle body control unit 61 then proceeds to step 705 to determine whether the engine SW 64 is pressed based on the operation signal from the engine SW 64.

When the engine SW 64 is not pressed, the vehicle body control unit 61 makes a “No” determination at step 705 and executes the process of step 705 again.

When the engine SW 64 is pressed, the vehicle body control unit 61 makes a “Yes” determination at step 705 and proceeds to step 706, issues a key authentication request to the key control ECU 50, and then proceeds to step 707.

The vehicle body control unit 61 proceeds to step 707 to determine whether the key authentication by the key control ECU 50 is successful.

When the key authentication is not successful, the vehicle body control unit 61 makes a “No” determination at step 707 and returns to step 707.

When the key authentication is successful, the car body control unit 61 makes a “Yes” determination at step 707, executes steps 708 and 709 described below in sequence, and then proceeds to step 710.

Step 708: The vehicle body control unit 61 turns on the accessory power and ignition power and starts the engine.

Step 709: The vehicle body control unit 61 controls the driving of the vehicle SV in response to steering wheel operation, brake operation, and gas pedal operation.

The vehicle control unit 61 proceeds to step 710 to determine whether the engine SW 64 is pressed.

When the engine SW 64 is not pressed, the vehicle body control unit 61 makes a “No” determination at step 710 and executes step 710 again.

When the engine SW 64 is pressed, the vehicle body control unit 61 makes a “Yes” determination at step 710 and proceeds to step 711, issues a key authentication request to the key control ECU 50 and proceeds to step 712.

The vehicle control unit 61 proceeds to step 712 to determine whether the key authentication was successful.

When the key authentication is not successful, the vehicle body control unit 61 makes a “No” determination at step 712 and performs step 712 again.

When the key authentication is successful, the vehicle body control unit 61 makes a “Yes” determination at step 712 and proceeds to step 713 to set the accessory power and ignition power to OFF, stop the engine, and proceed to step 714.

At step 714, the vehicle control unit 61 determines whether the door SW 62 is pressed based on the operation signal from the door SW 62.

When the door SW 62 is not pressed, the car body control unit 61 makes a “No” determination at step 714 and performs step 714 again.

When the door SW 62 is pressed, the vehicle body control unit 61 makes a “Yes” determination at step 714 and proceeds to step 715 to issue a key authentication request to the key control ECU 50 via CAN communication and proceeds to step 716 to determine whether the key authentication by the key control ECU 50 is successful.

When the key authentication is not successful, the vehicle body control unit 61 makes a “No” determination at step 716 and executes step 714 again.

When the key authentication is successful, the car body control unit 61 makes a “Yes” determination at step 716 and proceeds to step 717, locks the door (door locked by the door lock mechanism 63), and returns to step 701.

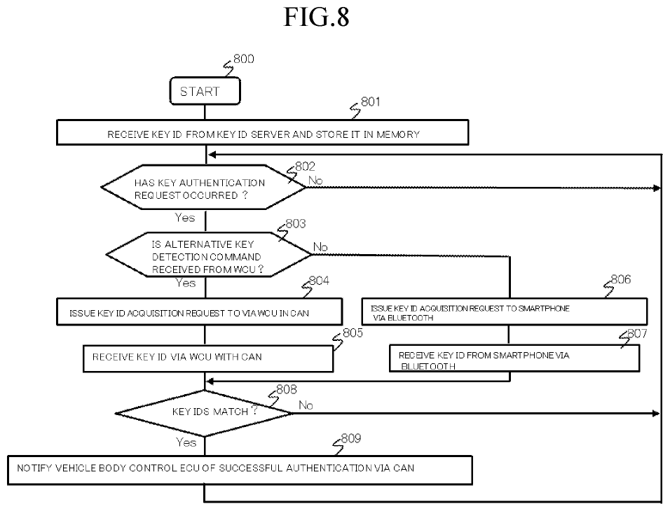

FIG. 8 is a flowchart illustrating the process performed by the key control ECU 50 to perform the key authentication requested by the vehicle body control ECU 60 when the smartphone 20 is charged and not charged as described above.

The key control unit 51 of the key control ECU 50 starts processing from step 800 and proceeds to step 801 to receive the key ID from the key ID server 40 and store it in memory 54.

The key control unit 51 then proceeds to step 802 to determine whether a key authentication request from the vehicle body control ECU 60 has occurred.

When a key authentication request has not occurred, the key control unit 51 makes a “No” determination at step 802 and executes the process at step 802 again.

When a key authentication request is generated, the key control unit 51 makes a “Yes” determination at step 802 and proceeds to step 803 to determine whether an alternative key detection command (command to start alternative key detection) is received from the WCU10.

When an alternative key detection command is received from the WCU 10, the key control unit 51 makes a “Yes” determination at step 803, executes steps 804 and 805 described below in sequence, and then proceeds to step 808.

Step 804: The key control unit 51 issues a key ID acquisition request (key ID request) to the smartphone 20 via the WCU 10 in CAN communication.

Step 805: The key control unit 51 receives the key ID from the smartphone 20 via the WCU 10 via CAN communication.

When no alternative key detection command is received from WCU10, the key control unit 51 makes a “No” determination at step 803, executes steps 806 and 807 described below in sequence, and then proceeds to step 808.

Step 806: The key control unit 51 issues a key ID acquisition request (key ID request) to the smartphone 20 via Bluetooth communication.

Step 807: The key control unit 51 receives the key ID from the smartphone 20 via Bluetooth communication.

The key control unit 51 proceeds to step 808 to determine whether the key IDs match.

When the key IDs do not match, the key control unit 51 makes a “No” determination at step 808 and returns to step 802.

When the key IDs match, the key control unit 51 makes a “Yes” determination at step 808 and proceeds to step 809 to notify the vehicle body control ECU 60 of successful authentication via CAN, then returns to step 802.

### <Effect>

As explained above, the first smartphone key system can avoid adverse effects on wireless communication for authentication and reduce the possibility of an increase in the time required for recharging. Furthermore, the first smartphone key system can reduce the number of recharges, which reduces the possibility of accelerated deterioration of the rechargeable battery 25. The first smartphone key system can copy the key ID during charging to the WCU 10 and perform key detection with priority, thus stabilizing communication.

### Second Embodiment

The following is a description of a smartphone key system for a vehicle including the WCU 10 (hereinafter referred to as the “second smartphone key system”). The second smartphone key system differs from the first smartphone key system only in the following points.

The second smartphone key system uses Near Field Communication (NFC) to authenticate keys for door locking and unlocking operations.

The following explanation focuses on these differences.

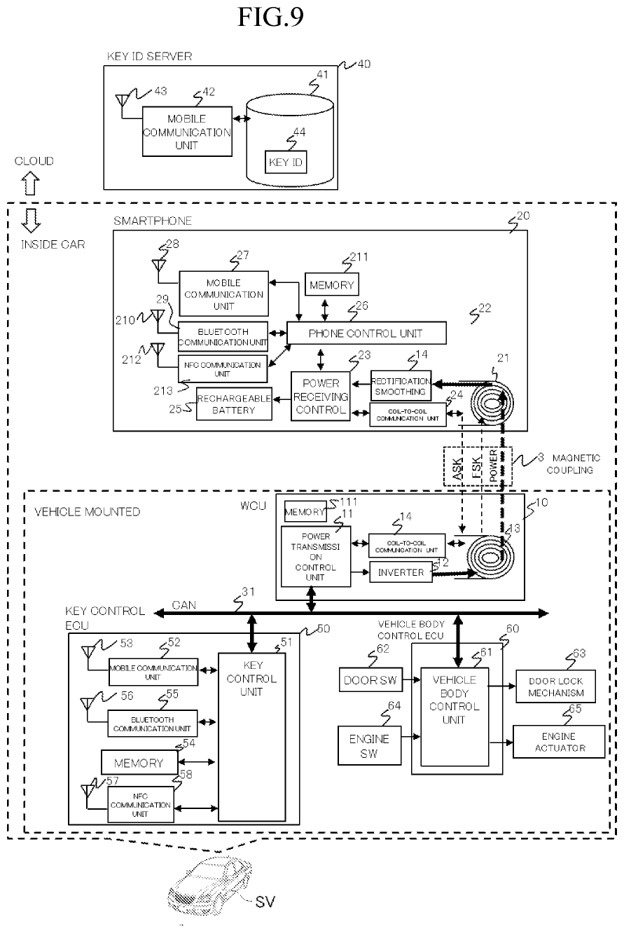

FIG. 9 shows an example configuration of the second smartphone key system. As shown in FIG. 9, in this second smartphone key system, the smartphone 20 is equipped with an antenna 212 and an NFC communication unit 213, and the key control ECU 50 is equipped with an antenna 57 (for example, the antenna 57 is built into the outside handle of the vehicle SV) and an NFC communication unit 58. The NFC communication part 213 comprises an NFC communication module connected to antenna 212. The NFC communication unit 58 comprises an NFC communication module connected to the antenna 57. The key control ECU 50 and the smartphone 20 are configured to send and receive information by NFC communication. Other than the above points, the configuration is similar to that of the first smartphone key system shown in FIG. 1.

### <Overview>

In the second smartphone key system, the communication for the key authentication for locking and unlocking the doors of the vehicle SV is performed by NFC. Other than the above points, the system is similar to the first smartphone key system. According to the second smartphone key system, when the WCU10 is charging the smartphone (charging execution state), without stopping charging, the smartphone 20 communicates with the WCU10 and the key control ECU 50 for the key authentication using the key ID stored in the WCU10 to thereby perform the key authentication. Furthermore, the second smartphone key system uses NFC communication, which is wireless communication over a short distance, for communication for the key authentication to unlock the door, thus preventing relay attacks.

In the second smartphone key system, the smartphone 20 is configured to operate without power supply using the electromotive force of the dielectric power generated when the smartphone 20 is brought close to the antenna 57 to transmit the key ID stored in the memory 211 via NFC communication. Therefore, the key control ECU 50 can detect the key ID from the smartphone 20 by NFC even when the smartphone 20 is not activated (when the power is turned off or when the remaining rechargeable battery power is below the minimum activation value (electromotive force required to activate the smartphone 20)).

### <Overall Operation of Second Smartphone Key System>

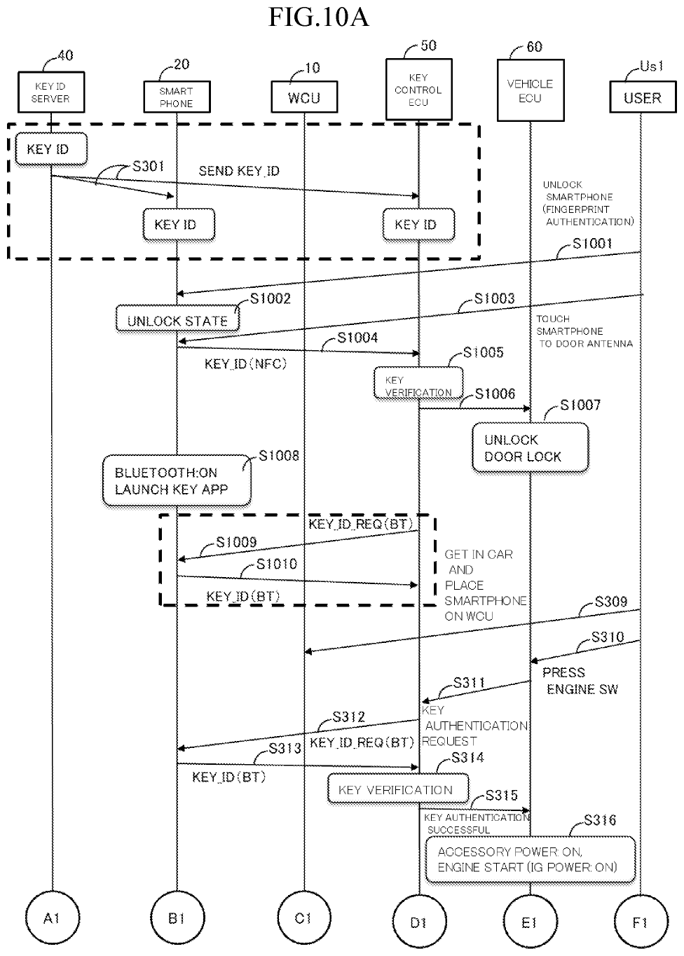

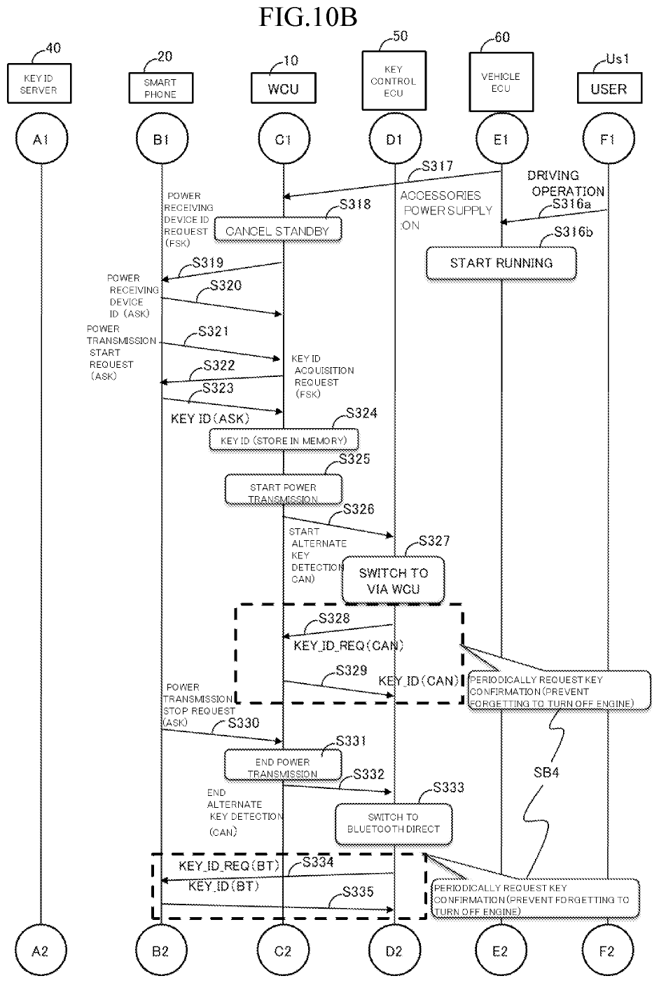

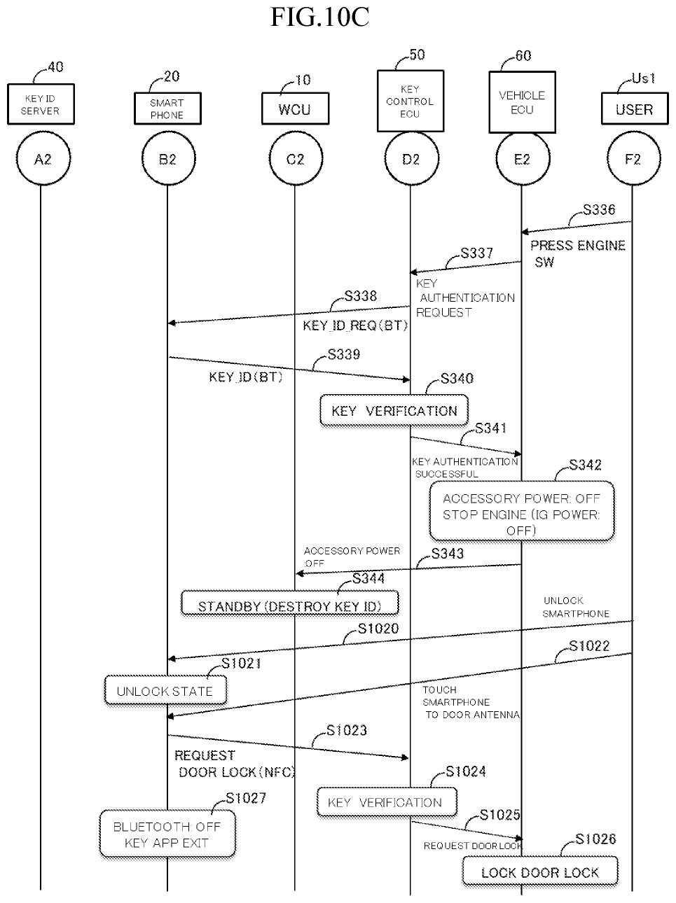

FIG. 10A through FIG. 10C are sequence diagrams to explain the respective operations of the key ID server 40, the smartphone 20, the WCU 10, the key control ECU 50 and the car body control ECU 60 when the user Us1 uses the second smartphone key system.

FIG. 10A is similar to FIG. 3A except that S302 to S308 in FIG. 3A are replaced by S1001 to S1010. FIG. 10B is similar to FIG. 3A. FIG. 10C is similar to FIG. 3C except that S345 to S352 in FIG. 3C are replaced by S1020 to S1027. Therefore, in the following, only the differences will be explained, and the points that overlap with FIGS. 3A through 3C will be omitted since they have already been explained.
S1001: The user Us1 performs fingerprint authentication to unlock the lock status of the smartphone 20.
S1002: The smartphone 20 in the locked state is unlocked.
S1003: The user Us1 touches the smartphone 20 to the door antenna (the antenna 212).
S1004: The smartphone 20 transmits the key ID to the key control ECU 50 via NFC communication.
S1005: When the key control ECU 50 receives the key ID from the smartphone 20, it performs the key authentication by matching the key with the received key ID.
S1006: The key control ECU 50 successfully authenticates the key and transmits the key authentication result to the vehicle body control ECU 60.
S1007: When the vehicle body control ECU 60 receives the key authentication result, it unlocks the door lock state (changes the door lock state to the door unlock state).
S1008: The smartphone 20 turns on Bluetooth communication and launches the key application (key application).
S1009: The key control ECU 50 sends a key ID request to the smartphone 20 via Bluetooth communication.
S1010: When the smartphone 20 receives the key ID request from the key control ECU 50, it transmits the key ID to the key control ECU 50 via Bluetooth communication. At S1009 and S1010, the key control ECU 50 transmits the key ID request at S1009 periodically and repeatedly (e.g., repeated every predetermined time) at a cycle (e.g., a cycle of several seconds or minutes) according to the driving status (stop or run) of the vehicle SV. When there is no response from the smartphone 20 to the key ID request, the key control ECU 50 determines that the engine has been turned off and notifies the smartphone 20 of the alert. The communication at this time is performed by mobile communication.
S1020 through S1026 in FIG. 10C are explained below.
S1020: The User Us1 unlocks the smartphone 20 by fingerprint authentication.
S1021: The smartphone 20 in the locked state is unlocked.
S1022: The User Us1 touches the smartphone 20 to the door antenna (the antenna 212).
S1023: The smartphone 20 sends a door lock request to the key control ECU 50 via NFC.
S1024: When the key control ECU 50 receives the key ID from the smartphone 20, it performs the key authentication by matching the key with the received key ID.
S1025: The key control ECU 50 successfully authenticates the key and sends a door lock request to the vehicle body control ECU 60.
S1026: When the vehicle body control ECU 60 receives the door lock request, it locks the door (puts the door in the door lock state).
S1027: The smartphone 20 turns off Bluetooth communication and terminates the key application (key application).

### <Specific Operation>

The specific operations of the key ID server 40, the smartphone 20, the WCU 10, the key control ECU 50, and the car body control ECU 60 are described below. The specific operation of the key ID server 40 is the same as the process described using FIG. 4, so the explanation is omitted.

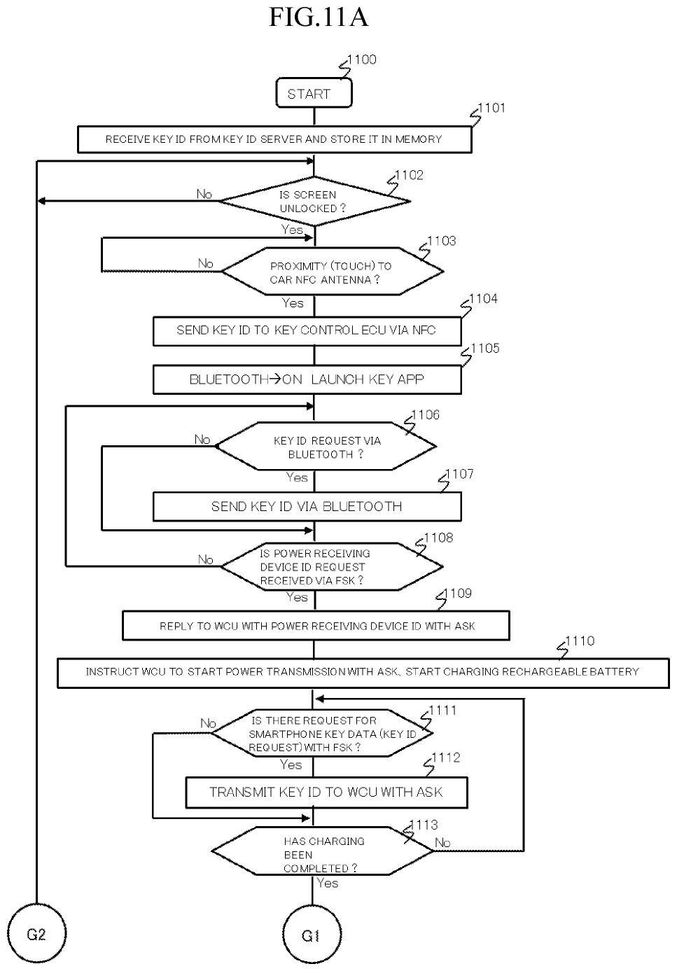

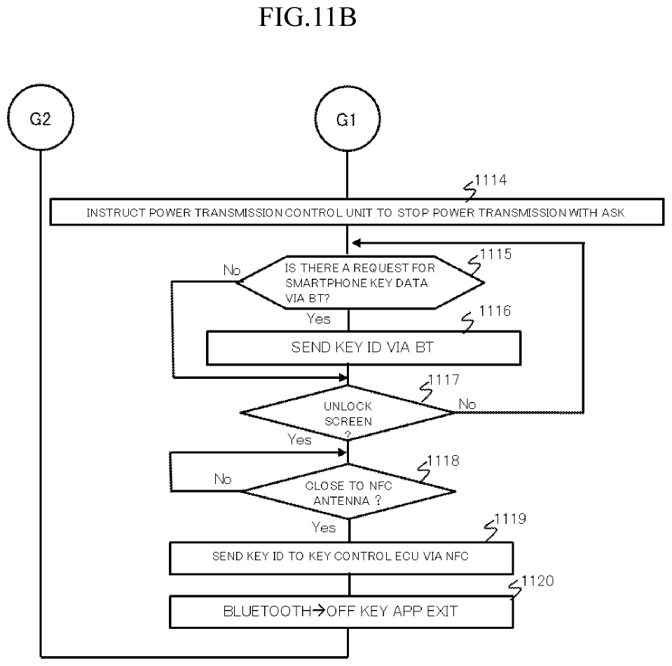

FIG. 11A and FIG. 11B are flowcharts for explaining the process performed by the smartphone 20 for the key authentication when the door is locked and unlocked, as well as when the smartphone 20 is charged and uncharged, as described above. The power receiving control unit 23 of the smartphone 20 starts the process at step 1100 and proceeds to step 1101 to receive the key ID from the key ID server 40 and store it in the memory 211.

The power receiving control unit 23 then proceeds to step 1102 to determine whether the screen is unlocked.

When the screen is not unlocked, the power receiving control unit 23 makes a “No” determination at step 1102 and returns to step 1101.

When the screen is unlocked, the power receiving control unit 23 makes a “Yes” determination at step 1102 and proceeds to step 1103 to determine whether the smartphone 20 is in proximity (touched) to the antenna 57 of the vehicle SV (for example, this is determined by generating a magnetic field with coil 21 and determining whether or not there is a response to the command). The vehicle SV is then touched by the antenna 57 of the vehicle SV.

When the smartphone 20 is not in proximity (not touched) to the antenna 57 of the vehicle SV, the power receiving control unit 23 makes a “No” determination at step 1103 and performs step 1103 again.

When the smartphone 20 is in proximity (touched) to the antenna 57 of the vehicle SV, the power receiving control unit 23 makes a “Yes” determination at step 1103, executes steps 1104 and 1105 described below in sequence, and then proceeds to step 1106.

Step 1104: The power receiving control unit 23 transmits the key ID to the key control ECU 50 via NFC communication.

Step 1105: The power receiving control unit 23 turns on Bluetooth communication and launches the key application.

The power receiving control unit 23 then proceeds to step 1106 to determine whether there is a key ID request from the key control ECU 50 via Bluetooth communication.

When there is a key ID request, the power receiving control unit 23 makes a “Yes” determination at step 1106 and proceeds to step 1107, transmits the key ID to the key control ECU 50 via Bluetooth communication and proceeds to step 1108.

When there is no key ID request, the power receiving controller 23 makes a “No” determination at step 1106 and proceeds directly to step 1108.

The power receiving control unit 23 proceeds to step 1108 to determine whether a power receiving device ID request is received from the WCU 10 with FSK.

When the power receiving device ID request is not received from WCU10 with FSK, the power receiving control unit 23 makes a “No” determination at step 1108 and returns to step 1106.

When a power receiving device ID request is received from the WCU10 with FSK, the power receiving control unit 23 makes a “Yes” determination at step 1108, executes steps 1109 and 1110 described below in sequence, and then proceeds to step 1111.

Step 1109: The power receiving control unit 23 replies to the WCU 10 with the power receiving device ID with ASK.

Step 1110: The power receiving control unit 23 instructs the WCU 10 to start power transmission with ASK. The power receiving control unit 23 starts charging the rechargeable battery 25 with the power transmitted from the WCU10.

The power receiving control unit 23 proceeds to step 1111 to determine whether there is a request for smartphone key data (key ID request) with FSK from the WCU10.

When there is a request for smartphone key data (key ID request), the power receiving control unit 23 makes a “Yes” determination at step 1111 and proceeds to step 1112, transmits the key ID to the WCU 10 with ASK, and proceeds to step 1113.

When there is no request for smartphone key data (key ID request), the power receiving control unit 23 makes a “No” determination at step 1111 and proceeds directly to step 1113.

The power receiving control unit 23 proceeds to step 1113 to determine whether charging has been completed. When charging has not been completed, the power receiving control unit 23 makes a “No” determination at step 1113 and returns to step 1111. When charging has finished/has been completed, the power receiving control unit 23 makes a “Yes” determination at step 1113 and proceeds to step 1114 of FIG. 11B to instruct the power transmission control unit 11 of the WCU 10 to stop power transmission with ASK and proceeds to step 1115.

The power receiving control unit 23 proceeds to step 1115 to determine whether there is a request for smartphone key data (key ID request) from the key control ECU 50 via Bluetooth communication.

When there is a request for smartphone key data (key ID request), the power receiving control unit 23 makes a “Yes” determination at step 1115 and proceeds to step 1116 to transmit the key ID via Bluetooth communication, then proceeds to step 1117.

When there is no request for smartphone key data (key ID request), the power receiving control unit 23 makes a “No” determination at step 1115 and proceeds directly to step 1117.

The power receiving control unit 23 proceeds to step 1117 to determine whether the screen is unlocked.

When the screen is not unlocked, the power receiving control unit 23 makes a “No” determination at step 1117 and returns to step 1115.

When the screen is unlocked, the power receiving control unit 23 makes a “Yes” determination at step 1117 and proceeds to step 1118 to determine whether the smartphone 20 is in proximity (touched) to the antenna of the vehicle SV.

When the smartphone 20 is not in proximity (not touched) to the antenna of the vehicle SV, the power receiving control unit 23 makes a “No” determination at step 1118 and performs step 1118 again.

When the smartphone 20 is in proximity (touched) to the antenna of the vehicle SV, the power receiving control unit 23 makes a “Yes” determination at step 1118, executes steps 1119 and 1120 described below in sequence, and then returns to step 1102 in FIG. 11A.

Step 1119: The power receiving control unit 23 transmits the key ID to the key control ECU 50 via NFC communication.

Step 1120: The power receiving control unit 23 turns off Bluetooth communication and terminates the key application.

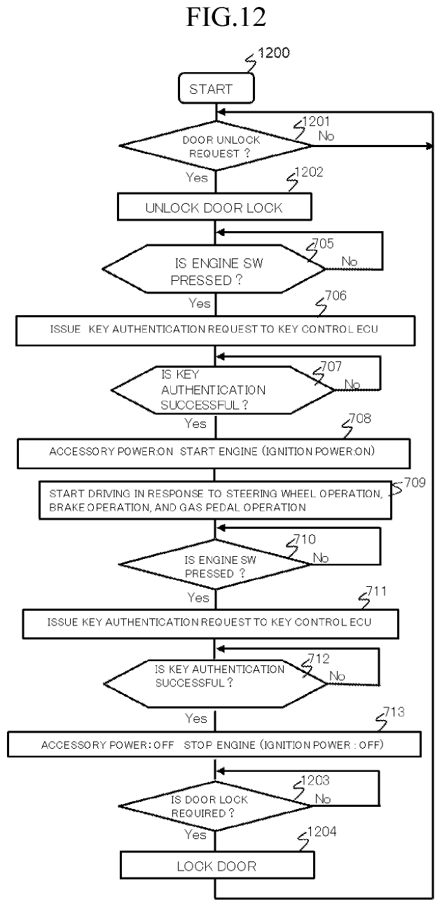

FIG. 12 is a flowchart to explain the process performed by the vehicle body control ECU 60 to perform the key authentication as described above and to control the operation of the vehicle SV according to the operation of each SW by the user Us1 and the result of the key authentication. The flowchart of FIG. 12 differs from the flowchart in the following points only.

Steps 701 through 704 are replaced by steps 1201 and 1202, and steps 714 through 716 are replaced by steps 1203 and 1204. Therefore, in the description of the flowchart in FIG. 12, only the processes that differ from the flowchart in FIG. 7 are described in detail, and descriptions of duplicate processes are omitted as appropriate.

The vehicle body control unit 61 of the vehicle control ECU 60 starts the process at step 1200 and proceeds to step 1201 to determine whether there is an unlock door lock request from the key control ECU 50.

When there is no unlock door lock request, the vehicle body control unit 61 makes a “No” determination at step 1201 and returns to step 1201.

When there is an unlock door lock request, the vehicle body control unit 61 makes a “Yes” determination at step 1201 and proceeds to step 1202 to unlock the door lock state using the door lock mechanism 63.

Thereafter, the vehicle body control unit 61 performs steps 705 through 713 in the order previously described, and then proceeds to step 1203 to determine whether a door lock request is received.

When there is no door lock request, the vehicle body control unit 61 makes a “No” determination at step 1203 and performs step 1203 again.

When there is a door lock request, the vehicle body control unit 61 makes a “Yes” determination at step 1203 and proceeds to step 1204, locks the door (door locked by the door lock mechanism 63), and returns to step 1201.

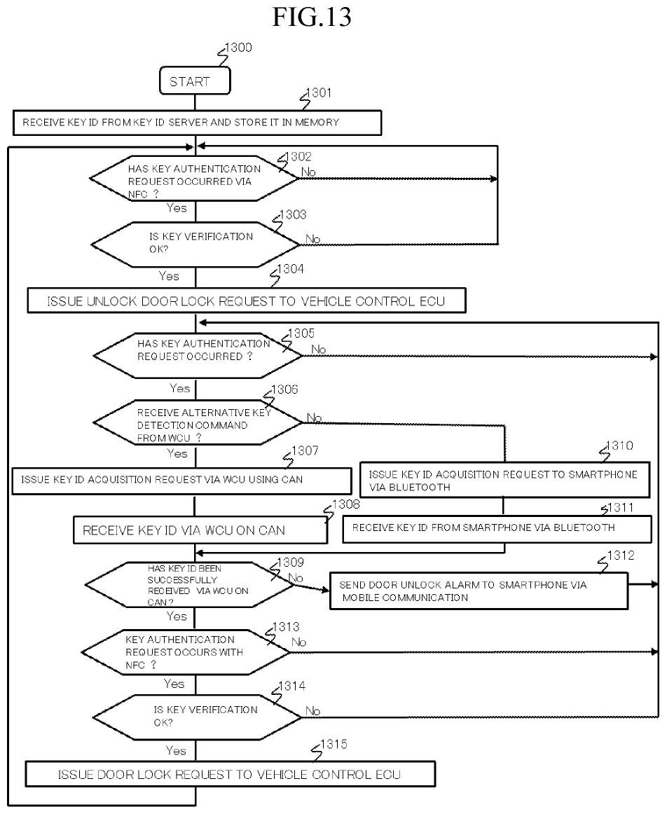

FIG. 13 is a flowchart illustrating the process performed by the key control ECU 50 to perform the key authentication when the smartphone 20 is charged and uncharged as described above.

The key control unit 51 of the key control ECU 50 starts the process at step 1300 and proceeds to step 1301 to receive the key ID from the key ID server 40 and store it in the memory 54.

The key control unit 51 then determines whether a key authentication request has been generated by NFC.

When no key authentication request is generated by NFC, the key control unit 51 makes a “No” determination at step 1302 and executes the process of step 1302 again.

When the key authentication request is generated by NFC, the key control unit 51 makes a “Yes” determination at step 1302 and proceeds to step 1303 to determine whether the key matching is OK or not.

When the key matching is not OK, the key control unit 51 makes a “No” determination at step 1303 and returns to step 1302.

When the key verification is OK, the key control unit 51 makes a “Yes” determination at step 1303 and proceeds to step 1304 to issue an unlock door lock request to the vehicle body control ECU 60 and proceeds to step 1305 to determine whether a key authentication request has occurred.

When the key authentication request has not occurred, the key control unit 51 makes a “No” determination at step 1305 and executes the process in step 1305 again.

When the key authentication request is generated, the key control unit 51 makes a “Yes” determination at step 1305 and proceeds to step 1306 to determine whether an alternative key detection command is received from the WCU 10.

When an alternative key detection command is received from the WCU 10, the key control unit 51 makes a “Yes” determination at step 1306, executes steps 1307 and 1308 described below in sequence, and then proceeds to step 1309.

Step 1307: The key control unit 51 issues a key ID acquisition request (key ID request) to the smartphone 20 via the WCU 10 in CAN communication.

Step 1308: The key control unit 51 receives the key ID from the smartphone 20 via the WCU 10 via CAN communication.

When no alternative key detection command is received from the WCU 10, the key control unit 51 makes a “No” determination at step 1306, executes steps 1310 and 1311 described below in sequence, and then proceeds to step 1309.

Step 1310: The key control unit 51 issues a key ID acquisition request (key ID request) to the smartphone 20 via Bluetooth communication.

Step 1311: The key control unit 51 receives the key ID from the smartphone 20 via Bluetooth communication.

The key control unit 51 proceeds to step 1309 to determine whether the key ID has been successfully received.

When reception of the key ID fails, the key control unit 51 makes a “No” determination at step 1309 and proceeds to step 1312 to send a door unlock alarm to the smartphone 20 via mobile communication and then returns to step 1305. For example, when the smartphone 20 receives the door unlock alarm, it displays a screen to notify user Us1 that he/she has left the car with the engine running. The smartphone 20 may also alert the user Us1 by sound, vibration, or other means.

When the key ID is successfully received, the key control unit 51 makes a “Yes” determination at step 1309 and proceeds to step 1313 to determine whether a key authentication request is generated by NFC.

When no key authentication request is generated by NFC, the key control unit 51 makes a “No” determination at step 1313 and returns to step 1305.

When a key authentication request is generated by NFC, the key control unit 51 makes a “Yes” determination at step 1313 and proceeds to step 1314 to determine whether the key matching is OK (the key authentication was successful).

When key matching is not OK (the key authentication failed), the key control unit 51 makes a “No” determination at step 1314 and returns to step 1305.

When the key verification is OK, the key control unit 51 makes a “Yes” determination at step 1314 and proceeds to step 1315 to issue a door lock request to the vehicle body control ECU 60 and then returns to step 1302.

### <Effect>

As explained above, the second smartphone key system has the same effects as the first smartphone key system. Furthermore, the second smartphone key system prevents relay attacks by using NFC to control the door lock, because the door of the vehicle SV cannot be unlocked unless the smartphone 20 is brought close to the antenna 57. Furthermore, the second smartphone key system can reduce the possibility of the user Us1 forgetting his/her smartphone 20 inside the vehicle SV, since the door of the vehicle SV cannot be locked without touching (proximity to) the antenna 57 from outside the vehicle SV. The second smartphone key system can detect the key ID with NFC even when the smartphone 20 is not activated (when the power is off or the remaining power in the rechargeable battery 25 is at the minimum activation value (less than the electromotive force required to activate the smartphone 20)).

### <<Variations>>

The present invention is not limited to the above embodiments, and various variations may be employed within the scope of the present invention. Furthermore, the above embodiments can be combined with each other as long as they do not depart from the scope of the present invention.

In each of the above embodiments, depending on the communication error situation, the key control ECU 50 may switch the communication to obtain the key ID, which is performed by Bluetooth communication, to coil-to-coil communication during the key authentication. For example, the key control ECU 50 may obtain the key ID (copy key ID) from the WCU 10 through CAN communication between the WCU 10 and the key control ECU 50 instead of Bluetooth communication when Bluetooth communication error occurs. This allows the key authentication to be performed even when Bluetooth communication cannot be connected. In each of the above embodiments, the key ID may be encrypted in CAN communication. In each of the above embodiments, LAN communication may be used instead of CAN communication.

The present invention can also be configured as follows.

[1] A method using a computer applied to a smartphone key system for vehicle using a smartphone as a vehicle key, the smartphone including a power receiving coil and a rechargeable battery that can be charged by power supplied from the power receiving coil, the smartphone key system comprising:
a key authentication device that is configured to communicate wirelessly with the smartphone and authenticate using authentication information; and
a wireless charging device communicatively connected to the key authentication device, the wireless charging device including the power transmission coil, the wireless charging device being capable of:
   communicating wirelessly with the smartphone through coil-to-coil communication via the power transmission coil and the power receiving coil, and
   transmitting power wirelessly via the power transmission coil to the power receiving coil, the wireless charging device including a storage unit that stores copy authentication information, the copy authentication information being authentication information of a copy of master authentication information held by the smartphone,
the method to be executed performed using computer, the method comprising selecting any one of the master authentication information and the copy authentication information for using as the authentication information depending on a state of the charging operation to the smartphone, the master authentication information being transmitted from the smartphone to the key authentication device by the wireless communication, the copy authentication information being stored in the memory unit, the copy authentication information being obtained from the smartphone by the coil-to-coil communication and transmitted by communication between the key authentication device and the wireless charging device.

[2]

A non-transitory computer-readable storage medium storing a computer-executable program executed by a computer, the program comprising instructions for executing the method in [1].

What is claimed is:

1. A wireless charging device installed in a vehicle, the wireless charging device being connected to a key authentication device configured to be capable of communicating wirelessly with a smartphone including a power receiving coil and a rechargeable battery that can be charged by power supplied from the power receiving coil, the key authentication device authenticating using authentication information,
wherein,
the wireless charging device comprises:
a power transmitting unit that includes a power transmission coil and is capable of:
communicating wirelessly with the smartphone through coil-to-coil communication via the power transmission coil and the power receiving coil; and
transmitting power wirelessly via the power transmission coil to the power receiving coil;
a storage unit that stores copy authentication information, the copy authentication information being authentication information of a copy of master authentication information held by the smartphone;
and
a control unit configured to instruct the key authentication device to select any one of the master authentication information and the copy authentication information for using as the authentication information depending on a state of charging operation to the smartphone, the master authentication information being transmitted from the smartphone to the key authentication device by wireless communication, the copy authentication information being stored in the memory unit, the copy authentication information being obtained from the smartphone by the coil-to-coil communication and transmitted by communication between the key authentication device and the wireless charging device.

2. The wireless charging device according to claim 1,
wherein,
the control unit is configured to:
instruct, when the state of the charging operation to the smartphone is in a charging execution state where power for charging is being transmitted to the smartphone, the key authentication device to acquire the copy authentication information as the authentication information through communication between the key authentication device and the wireless charging device; and
instruct, when the state of the charging operation to the smartphone is in a non-charging state where the transmission of power for charging is stopped, the key authentication device to acquire the master authentication information as the authentication information through the wireless communication.

3. The wireless charging device according to claim 2,
wherein,
the control unit is configured to:
acquire, when the copy authentication information is not stored in the memory unit in a case where there is a request from the smartphone to transmit power for charging, the authentication information used for the authentication from the smartphone by the coil-to-coil communication before transmitting power for charging by the power transmitting unit to store the acquired authentication information in the memory unit; and
discard, thereafter, the copy authentication information from the memory unit at a predetermined timing.

4. The wireless charging device according to claim 1,
wherein,
the coil-to-coil communication transmits:
a signal generated by FSK (frequency shift keying) on the wireless charging device side to the smartphone using the power transmitted from the power transmission coil to the power receiving coil; and
a signal generated by ASK (Amplitude Shift Keying) on the smartphone side to the wireless charging device using the power.

5. The wireless charging device according to claim 1,
wherein,
Bluetooth communication or NFC communication is used as the wireless communication between the smartphone and the key authentication device; and
the NFC communication is used as the wireless communication for transmitting the master authentication information, when the power of the smartphone is in an OFF state, or when an amount of charge of the rechargeable battery of the smartphone is less than or equal to a minimum startup value.

6. The wireless charging device according to claim 2,
wherein,
Bluetooth communication is used as the wireless communication; and
the control unit is configured to instruct, even when the communication is switched from the wireless communication to the coil-to-coil communication, the smartphone and the key authentication device to maintain the connection without disconnecting the Bluetooth communication.

7. The wireless charging device according to claim 2,
wherein,
Bluetooth communication is used as the wireless communication; and
the control unit is configured to instruct, when the Bluetooth communication is an error, the key authentication device to obtain the copy authentication information as the authentication information.

8. The wireless charging device according to claim 1,
wherein,
NFC communication is used as the wireless communication for authentication when locking and unlocking the door.

9. A smartphone key system for vehicle using a smartphone as a vehicle key, the smartphone including a power receiving coil and a rechargeable battery that can be charged by power supplied from the power receiving coil,
the smartphone key system comprising:
a key authentication device that is configured to communicate wirelessly with the smartphone and authenticate using authentication information; and
a wireless charging device communicatively connected to the key authentication device, the wireless charging device including the power transmission coil, the wireless charging device being capable of:
communicating wirelessly with the smartphone through coil-to-coil communication via the power transmission coil and the power receiving coil, and
transmitting power wirelessly via the power transmission coil to the power receiving coil, the wireless charging device including a storage unit that stores copy authentication information, the copy authentication information being authentication information of a copy of master authentication information held by the smartphone,
wherein,
the smartphone key system is configured to select any one of the master authentication information and the copy authentication information for using as the authentication information depending on a state of charging operation to the smartphone, the master authentication information being transmitted from the smartphone to the key authentication device by the wireless communication, the copy authentication information being stored in the memory unit, the copy authentication information being obtained from the smartphone by the coil-to-coil communication and transmitted by communication between the key authentication device and the wireless charging device.

10. The smartphone key system for vehicle according to claim 9,
wherein,
when the state of the charging operation to the smartphone is in a charging execution state where power for charging is being transmitted to the smartphone, the copy authentication information is used as the authentication information,
when the state of the charging operation to the smartphone is in a charging non-execution state where the transmission of power for charging is stopped, the master authentication information is used as the authentication information.

11. The smartphone key system for vehicle according to claim 10,
wherein,
the wireless charging device is configured to:
acquire, when the copy authentication information is not stored in the memory unit in a case where there is a request from the smartphone to transmit power for charging, the authentication information used for the authentication from the smartphone by the coil-to-coil communication before transmitting power for charging by the power transmitting unit to store the acquired authentication information in the memory unit; and
discard, thereafter, the copy authentication information from the memory unit at a predetermined timing.

12. A smartphone used in the smartphone key system for vehicle of claim 9.

13. A vehicle to which the smartphone key system for vehicle of claim 9 is applied.

14. A method using a computer applied to a smartphone key system for vehicle using a smartphone as a vehicle key, the smartphone including a power receiving coil and a rechargeable battery that can be charged by power supplied from the power receiving coil,
the smartphone key system comprising:
a key authentication device that is configured to communicate wirelessly with the smartphone and authenticate using authentication information; and
a wireless charging device communicatively connected to the key authentication device, the wireless charging device including the power transmission coil, the wireless charging device being capable of:
communicating wirelessly with the smartphone through coil-to-coil communication via the power transmission coil and the power receiving coil, and
transmitting power wirelessly via the power transmission coil to the power receiving coil, the wireless charging device including a storage unit that stores copy authentication information, the copy authentication information being authentication information of a copy of master authentication information held by the smartphone,
the method to be executed performed using computer, the method comprising selecting any one of the master authentication information and the copy authentication information for using as the authentication information depending on a state of the charging operation to the smartphone, the master authentication information being transmitted from the smartphone to the key authentication device by the wireless communication, the copy authentication information being stored in the memory unit, the copy authentication information being obtained from the smartphone by the coil-to-coil communication and transmitted by communication between the key authentication device and the wireless charging device.

15. A non-transitory computer-readable storage medium storing a computer-executable program executed by a computer, the program comprising instructions for executing the method in claim 14.
